(19) United States
(12) Patent Application Publication
(10) Pub. No.: US 2014/0098984 A1
(43) Pub. Date: Apr. 10, 2014

(54) LOUDSPEAKER CONSTRUCTED FROM SHEETS

(71) Applicants: Thilo-J. Werners, Leverkusen (DE); Michael Heite, Olpe (DE); Norman Gerkinsmeyer, Burgau (DE); Joachim Kistner, Baden-Baden (DE)

(72) Inventors: Thilo-J. Werners, Leverkusen (DE); Michael Heite, Olpe (DE); Norman Gerkinsmeyer, Burgau (DE); Joachim Kistner, Baden-Baden (DE)

(73) Assignee: Bayer MaterialScience AG

(21) Appl. No.: 14/104,330

(22) Filed: Dec. 12, 2013

Related U.S. Application Data
(63) Continuation of application No. 12/527,514, filed on Feb. 2, 2010.

(30) Foreign Application Priority Data
Feb. 17, 2007 (DE) 102007007957.7

(51) Int. Cl. H04R 7/06

(52) U.S. Cl. CPC H04R 7/06
USPC 381/423

(57) ABSTRACT

A loudspeaker designed with a large area having sandwich-like layer structure includes a plurality of conductive and nonconductive layers which form an active sound-radiating loudspeaker surface. The plurality of conductive and nonconductive layers include a first diaphragm sheet coated with an electrically conductive layer, a second diaphragm sheet coated with an electrically conductive layer, a static high-voltage supply, which generates an electric field between the first electrically conductive layer and the second electrically conductive layer, and an audio source which influences the high-voltage fields between the first electrically conductive layer and the second electrically conductive layer via a capacitor. The invention is distinguished in that, with the second electrically conductively coated diaphragm sheet, the first electrically conductively coated diaphragm sheet forms a sandwich which extends simply over the active loudspeaker surface, around a first elastic and nonconductive interlayer.

### CROSS REFERENCE TO RELATED APPLICATIONS

This application is a continuation of U.S. application Ser. No. 12/527,514, filed Feb. 2, 2010 and claims priority to national stage application, PCT/EP2008/051796, filed under 35 U.S.C. §371 on Feb. 14, 2008, which claims priority to German application 102007007957.7, filed Feb. 17, 2007. The disclosures of the aforementioned priority applications are incorporated herein by reference in their entirety.

### BACKGROUND

The invention relates to a loudspeaker constructed from sheets and at least two electrically conductive layers with an elastic interlayer, in which a constant high voltage, which is excited in oscillation by an audio source, is applied between the electrically conductive layers.

Similar loudspeakers with a multiple sandwich structure are widely known. In these, as a rule, a multiply wound or folded sandwich structure it is normally used in order to generate the sufficient sonic pressure, so that such loudspeakers lose their flexibility and are bulky.

For example, reference is made to document U.S. Pat. No. 3,544,733 which discloses an electrostatic loudspeaker that is constructed from conductive and nonconductive sheets, the active surface of the loudspeaker, however, consisting of a multiplicity of sheet sandwiches placed on one another. According to this document, furthermore, the interlayer between the conductive layers must be configured in a corrugated fashion in order to avoid flat contact of the layers. In order to obtain such corrugated interlayers, they must be relatively rigid so that, particularly in conjunction with the fact that the sandwiches are also wound and/or folded repeatedly on one another, the loudspeaker becomes rigid and inflexible overall.

Documents US 7,095,864 B1; DE 699 26 487 T2; U.S. pat. No. 4,885,783 and AT 382 490 B disclose laminated loudspeakers in which the diaphragms used do not have flat contact with the respective electrodes, i.e. between the diaphragms and at least one electrode there is an intermediate space which is filled for example with air or a gas. Such laminated loudspeakers, however, have the disadvantage that the loudspeaker is difficult to produce, in particular by using individual elastic layers or shaped bodies of the diaphragm material (intermediate material).

### SUMMARY OF THE INVENTION

It is an object of the invention to describe a laminated loudspeaker which on the one hand is as compact as possible, and on the other hand can be produced as easily as possible with large surface areas. Such a loudspeaker should furthermore be able to generate sonic pressures sufficiently and have good acoustic properties.

This object is achieved by the features of the independent patent claims. Advantageous refinements of the invention are the subject-matter of dependent claims.

The Inventors have discovered that in loudspeakers configured with a large area, it is not categorically necessary to maintain an area generating high sonic pressure per cm², rather that it is merely necessary to generate a sufficient sonic level overall by means of the sum of the total sound-generating surface. The effect of this, when the sound-generating surface is extended over a large area relative to the distance from the person listening, is that the sonic pressure is not reduced by 6 dB when the range is doubled; rather, an increase in the volume actually takes place initially with an increasing distance since the listener will initially be receptive to a larger part of the radiated sound, and merely a decrease respectively by 1 dB per doubling of the range will occur later.

According to this discovery for a loudspeaker dimensioned with a large area, when it has a sandwich structure as a laminated loudspeaker, is sufficient to construct it as a single or double sandwich, in which case an elastic interlayer is to be placed between two conductive layers arranged in a sandwich fashion and the conductive layers are connected to a sheet.

According to this basic concept, the Inventors provide a loudspeaker designed with a large area having sandwich-like layer structure, consisting of a plurality of conductive and nonconductive layers which form an active sound-radiating loudspeaker surface, having:
a first diaphragm sheet coated with an electrically conductive layer,
a second diaphragm sheet coated with an electrically conductive layer,
a static high-voltage supply, which generates an electric field between the first electrically conductive layer and the second electrically conductive layer, and
an audio source which influences the high-voltage fields between the first electrically conductive layer and the second electrically conductive layer via a capacitor.

According to the invention this loudspeaker designed with a large area is distinguished in that, with the second electrically conductively coated diaphragm sheet, the first electrically conductively coated diaphragm sheet forms a sandwich which extends simply over the active loudspeaker surface, around a first elastic and nonconductive interlayer.

In one embodiment of the present invention, according to the invention, at least one electrically conductive layer of the diaphragm sheets, and preferably at least two electrically conductive layers of the diaphragm sheets or more particularly preferably all the electrically conductive layers of the diaphragm sheets, has or have flat contact with the respective elastic and nonconductive interlayer. The term flat contact is intended to mean in particular that there are no intermediate spaces which, for example, may be filled with a gas such as air.

The effect achieved by this is that the interlayer may be introduced as a web or as a plate, i.e. as a continuous body, into the loudspeaker according to the invention, so that the production is simplified overall.

It should be pointed out that the active loudspeaker surface is to be understood as the cross-sectional area of the loudspeaker, perpendicular to the principal sound radiation direction, which generates sound by movement. The term “audio source” should furthermore be taken to mean any AC voltage source which is suitable for transmitting the audio frequencies to be generated to the respectively connected electrical layer in the form of a variable voltage, and for correspondingly modulating the electric field between the conductive layers.

In a refined embodiment, the Inventors propose that a third diaphragm sheet, coated with at least one electrically conductive layer, and a second elastic and nonconductive interlayer should be provided, which form a second sandwich that likewise extends simply over the active loudspeaker surface, the electrically conductive layer of the third diaphragm sheet likewise being connected to the high-voltage source in order to form a further electric field, this electric field also being influenced by the audio source.

According to the basic concept of the invention, the Inventors also provide a loudspeaker designed with a large area having sandwich-like layer structure, consisting of a plurality of conductive and nonconductive layers which form an active sound-radiating loudspeaker surface, wherein
at least one nonconductive layer is formed from a plastic sheet
a high-voltage potential (=bias) is applied between two conductive layers separated by a nonconductive interlayer and
at least one layer can be connected to a variable voltage supply which transmits electrical audio signals in the form of voltage variations to this layer
precisely one or precisely two nonconductive elastic interlayer(s) are provided, which, owing to their elasticity, allow movement of the neighbouring layers on at least one side of the interlayer(s) for sound generation,
each layer precisely extends simply over the active loudspeaker surface,
all the layers on the active loudspeaker surface are connected at least partially to the respectively neighbouring layer,
a stabilising and inertial element is connected to the active loudspeaker surface, and
a protective device is provided, which protects persons from the high-voltage potential in the two outer layers exposed to high voltage.

Advantageously, in the loudspeaker designs described above, at least one nonconductive elastic interlayer may consist of a material arranged inhomogeneously with regard to the dimension of its layer thickness. For example, this inhomogeneous nonconductive interlayer may be formed as an elastic foam. In principle both closed-pore and open-pore foam may be used in this case, although open-pore foam is more favourable in relation to the pressure equilibration required for the sound improvement.

If an open-pore foam is used, then in a preferred embodiment of the present invention this will likewise be in flat contact with the electrically conductive layers of the diaphragm sheet. This results in loudspeakers different to those described in the prior art U.S. Pat. No. 7,095,864 B1; DE 699 26 487 T2; U.S. Pat. No. 4,885,783; U.S. Pat. No. 3,544,733 and AT 382 490 B.

Even with an open-pore foam, it is essentially not possible to pass from the front side to the rear side of the foam body in the direction of the surface normal. This applies a fortiori for a closed foam. This means that there is preferably an equally large area of the solid of the open-pore foam (c) between each surface unit of the first electrically conductive layer (b) and the second electrically conductive layer (d) in the direction of the surface normal (cf. the definition of references (b), (c) and (d) below).

In the case of an open-pore foam as the interlayer, the distribution of the support elements per unit area of the layers (b) and (c) is moreover essentially more narrow-meshed than for the individual support elements as they are described in the prior art cited above. In air, the wavelength of sound waves is approximately 17 m to 17 mm (assuming that the frequency range, in which humans can hear, is from 20 Hz to 20 kHz). The pore diameter of open-pore foam is much less than the wavelength of sound waves, so that no detrimental effects on the sound pattern are to be expected from the use of open-pore foam, whereas effects very much need to be taken into account with the large openings between support pillars in the prior art. Furthermore, the use of a closed or open-pore foam in the scope of the present invention achieves more uniform bracing than in the loudspeakers of the prior art.

The inhomogeneous nonconductive interlayer may furthermore be formed as an elastic textile surface structure of individual fibres without filler, a so-called nonwoven material. It should be pointed out in this regard that this nonwoven material is not paper, since paper comprises large proportions of inelastic filler and is therefore not suitable.

For economical production of the loudspeaker according to the invention, it is particularly favourable for at least one conductive layer to be applied directly on the surface of a sheet. In this way, for example, it is possible to use known commercially available coated sheets, preferably aluminium-coated sheets.

It is, however, also possible for at least one conductive layer to be applied directly on the surface of the elastic interlayer. This means, for example, that a foam or the like may be used as the interlayer, onto which the required conductive layer is applied on the surface. The application of these layers, both in the case of the sheets and in the case of the elastic interlayer, may be carried out by vacuum vapour deposition methods known per se or by so-called sputtering methods or screen printing methods, or alternatively intaglio printing methods.

In another specific embodiment of the loudspeaker according to the invention, the

Inventors propose that the stabilising and inertial element should be a frame, between which the acoustically active loudspeaker surface is tensioned. This variant is particularly favourable when the loudspeaker is configured as a double sandwich. This offers the possibility of tensioning an inherently very elastic and flexible sheet in a rigid frame, and for example hanging it in a large room so that the radiation direction of the loudspeaker takes place on both sides and very large spaces can therefore receive sound.

According to another variant of the loudspeaker according to the invention, a wall which is solid and heavy relative to the other layers, and which extends at least over the entire active loudspeaker surface, is provided as the stabilising and inertial element. With this alternative embodiment the active loudspeaker surface is thus backed on one side by a solid and heavy mass, so that the pulses generated between the conductive layers in the loudspeaker sandwich are uniquely directed at the front side of the loudspeaker. In this case, it is particularly advantageous for this heavy wall to be connected, for example adhesively bonded, surface-wide to the other layers of the loudspeaker at least over the active loudspeaker surface, so that separation of the active loudspeaker surface from the heavy wall is prevented and no separation phenomena possibly influencing the quality of the loudspeaker occur.

It is furthermore proposed that a stabilising and inertial element, extending flatly over the active loudspeaker surface, should have a mass per unit area which corresponds to at least 10 times, preferably at least 100 times, preferably at least 1000 times the mass per unit area of all the other layers of the loudspeaker.

In another embodiment of the present invention, the stabilising and inertial element is spatially designed so that the sound is deliberately radiated. The deliberately aligned arrangement of the sheet sonic transducer according to the invention is also advantageous in such a case.

Since high voltages are applied between the conductive layers of the loudspeaker according to the invention, albeit these merely generate a static field and therefore do not permit heavy currents, it may however be advantageous to provide an additional protective device against possible voltage sparkovers in the event of mechanical damage to the loudspeaker sheets, in which case such a protective device may be made from at least one additional conductive layer as a protective electrode, which forms the outermost conductive layer and has an earth connection.

With such a measure, piercing of the laminated loudspeaker leads to a direct short between the high voltage and the earth connection, so that the existing charge is immediately dissipated.

As an alternative or in addition to such a protective electrode, it is also possible to provide an electronic circuit which short-circuits and/or switches off the high-voltage supply in a hazardous situation. For example, an abnormal current flow at the high-voltage supply or a sudden voltage drop, which implies a short-circuit between audio potential and bias potential, may be detected as a hazardous situation.

The insulation layer is preferably formed imperviously to air bubbles. The insulation layer is furthermore preferably a layer which has a higher breakdown strength than air. The insulation layer may be applied in liquid form by means of printing technology or doctor blade technology or spray technology or dispenser technology, or in the form of a thin sheet. For example an (insulation) lacquer known from printed circuit board technology or a nonconductive plastic sheet, which is applied as the outermost layer of the laminated loudspeaker, may be used as the insulation layer.

With regard to the structure of the laminated loudspeaker according to the invention, the Inventors also propose that at least one layer directly neighbouring the elastic interlayer should be adhesively bonded to the elastic interlayer over the entire active loudspeaker surface. In order to improve the acoustic quality, it may furthermore be favourable for at least one layer directly neighbouring the elastic interlayer, and all the layers arranged above it in the direction of the surface, to have a multiplicity of openings.

Such openings lead to unimpeded pressure exchange between the outside and the elastic layer so that no additional compression work, besides the necessary compression of the elastic layer, is needed in order to compress enclosed air, or at least this is substantially avoided. Such openings may be arranged equidistantly at least in a direction along the loudspeaker surface. It is advantageous for the arranged openings to be distributed as uniformly as possible, i.e. overall distributed equidistantly and as far as possible congruently.

With regard to the specific dimensions of the loudspeaker according to the invention, the Inventors furthermore propose that an outer insulation layer which is formed from a plastic sheet should be provided, in which case this plastic sheet should preferably have a thickness of from 5 to 100 μm. In this range, thicknesses of between 10 and 70 μm, or further limited between 25 and 60 μm, have proven particularly favourable.

Between the at least two separated conductive layers, the loudspeaker according to the invention has at least one further layer. This layer is designed to be electrically nonconductive (dielectric layer). This layer may also be air.

What is crucial is that this layer should be designed so that no electrical contact takes place between the at least two separated conductive layers.

In a first configuration of the layer, the loudspeaker according to the invention has a layer which is designed to be air-permeable.

In a second configuration of the layer, the loudspeaker according to the invention has a layer which is elastically compressible.

In a third configuration of the layer, the loudspeaker according to the invention has a layer which has nonpolar and polar properties, i.e. a layer which has electret properties. The term electret in the scope of the present invention is intended to mean an electrical material which contains quasi-permanently stored electrical charges and/or quasi-permanently aligned electrical dipoles, and which therefore generates a quasi-permanent field in its vicinity and/or in its interior.

In a fourth configuration, the features mentioned above in the first to third configurations are combined in any desired way.

It is furthermore proposed that the interlayers, i.e. the one or two elastic interlayers provided according to the invention, should be configured with a thickness of from 0.1 mm to 5.0 mm, this range preferably being limited to from 0.2 mm to 3.0 mm.

A DC bias voltage of >500 V, preferably >1000 V, may then be applied between the conductive layers, in which case an audio voltage with a maximum amplitude of >200 volts can be applied. It is of course necessary to ensure that the maximum voltage amplitude of the audio voltage always remains less than the applied constant high voltage.

For example, according to a simple specific embodiment, such a sheet electrostatic loudspeaker may be fastened on a wall element, for example “wallpapered” on. In this basic embodiment, directional sound emission is already achieved over several metres to 100 m or more with an extremely thin layer structure of about 1 to 5 mm, in particular less than 4 mm and a dimension in the range of 0.5×0.5 m.

In the scope of the present invention the interlayer may be formed by a foam material, a nonwoven or elastic screen printing, the layer's properties according to the invention being achieved by selecting suitable materials. This electrically nonconductive layer may preferably be formed as an elastic foam.

In principle both closed-pore and open-pore foam may be used in this case, although open-pore foam is more favourable in relation to the pressure equilibration required for the sound improvement. Notwithstanding, a thin closed-pore foam based on the polymer materials mentioned below may also surprisingly be used, with outstanding sound emission qualities being obtained.

Furthermore, the nonconductive interlayer may also be formed as an elastic textile surface structure of individual fibres without filler, a so-called nonwoven material. It should be pointed out in this regard that this nonwoven material is not paper, since paper comprises large proportions of inelastic filler and is therefore generally not suitable.

The interlayer, which is preferably formed by a foam material, has a thickness of from 0.1 mm upwards.

In the scope of the present invention, the material of the diaphragm sheet is preferably selected from the group consisting of polycarbonate (PC), oriented polypropylene (OPP), polypropylene (PP), polyethylene terephthalate (PET), acrylonitrile-butadiene-styrene rubber (ABS), polyvinyl fluoride (PVF), polymethyl methacrylate (PMMA), polyethylene (PE), biaxially oriented polypropylene (BOPP), polyethylene terephthalate (PTFE), polyvinyl chloride (PVC), polyether ether ketone (PEEK) and polyimide (PI). Sheets of polypropylene and polycarbonate are particularly preferred, especially sheets of polycarbonate.

The polymer sheet in the sound-emitting electrode preferably has a thickness of from 5 to 500 μm, particularly preferably from 10 to 200 μm, in particular from 15 to 100 μm.

In such a basic embodiment, an approximately 15 to 100 μm thick polycarbonate thin sheet may be used with an electrically conductive rear side coating. The electrically conductive rear side coating may be adhesively bonded flatly to the front side of the foam by means of commercially available bonder systems. Furthermore, a rear side sheet with a rear side electrically conductive coating may be adhesively bonded flatly to the rear side of the foam and the rear side of the electrode may simultaneously be adhesively bonded to a carrier element.

The requirements of the bonders being used consist in good and long-lasting connection of the bonding partners with the thinnest possible material application. In principle adhesive systems containing a solvent, 2-component adhesive systems as well as reactive or semi-reactive adhesive systems or hot-melt adhesive systems may in principle be used for this.

The preferred surface resistivity of the electrically conductive layers is dependent on the sound-emitting element, and it may be more than 2000 ohm/square for small-area elements and less than 500 ohm/square for large-area elements. The surface resistivity is preferably less than 2000 ohm/square, in particular less than 1000 ohm/square.

The electrical conductivity may be obtained in various ways. To this end, for example, an electrically conductive layer is provided on a corresponding sheet material, or alternatively the intermediate material. This is possible for example by producing the electrical layer using a roll technique, roller coating, doctor blade coating, a curtain casting method, spray coating, a transfer method or electrolytic technology. As an alternative, it is readily possible to produce the electrically conductive layer by printing technology with an electrically conductive printing paste. Further application methods for the electrically conductive layer are, for example, so-called vacuum application methods such as the sputtering method or vapour deposition method; screen printing methods (offset printing, flexographic printing, screen intaglio printing); inkjet methods or intaglio printing methods.

The conductive layer may for example be based on a silver paste, a paste containing CNT (CNT=particles with nanostructures), a copper paste or an intrinsically electrically conductive polymer, or the combination of two or more of the said materials.

It is also possible—as mentioned—to use a sheet material made of an electrically conductive material (for example an electrically conductive polymer).

Corresponding conductive polymers are, for example, intrinsically conductive polymers which are ethylenically unsaturated and conjugated, so that easy charge transport is possible in the polymer molecule. Such polymers are also referred to as organic metals. They have a conductivity of at least 10⁻⁵, preferably at least 10⁻², particularly preferably at least 1 Siemens/cm. Suitable intrinsically conductive polymers are, for example, selected from polymers based on polyaniline, polyanisidine, polydiphenyl amine, polyacetylene, polythiophene, polythioprene, polythienylene vinylene, bithiophene, polypyrrole and polycroconaine and their derivatives. Such polymers are often rendered electrically conductive by means of doping. This may be done chemically or electrochemically. By treatment with oxidising agents such as iodine, sodium peroxydisulfate or bromine or a strong acid, suitable polymers become partially oxidised and therefore electrically conductive. Other polymers may be rendered electrically conductive by partial reduction with reducing agents. These methods are widely known. The production of intrinsically conductive polyaniline and polypyrrole is described, for example, in EP 0 539 123. Suitable polymers are, for example, polyradical cations. For increased stability of the formulations, it is recommendable for the polyradical cations to be used in combination with polymer anionic compounds (polyanions) and for the compositions to contain no further cationic substances, the counter-ions of which compete for the polyanions and lead to precipitates.

Preferred conductive polymers are conductive polythiophenes, in particular conductive polyalkylene dioxythiophenes. The production is described, for example, in DE 41 18 704 and EP 0 339 340. One preferred conductive polymer is 3,4-polyethylene dioxythiophene. A suitable commercial product is Baytron® P from Bayer, an aqueous dispersion with 0.5 wt. % 3,4-polyethylene dioxythiophene (PEDOT) and 0.8 wt. % polystyrene sulfonate (PSS). Other preferred intrinsically conductive polymers are conductive polyanilines, for example Versicon® (Allied Signal), a polyaniline with a conductivity of 2-4 S/cm or Ormecon® (Zipperling Kessler & Co).

If an electrically conductive layer containing CNT is used, for example by applying a printing paste, then this may contain particles with nanostructures. In the scope of the present invention, the term “particles with nanostructures” is intended to mean nanoscale material structures which are selected from the group consisting of single-wall carbon nanotubes (SWCNTs), multi-wall carbon nanotubes (MWCNTs), nanohorns, nanodiscs, nanocones (i.e. structures in the shape of a lateral cone surface), metal nanowires and combinations of the aforementioned particles. Corresponding particles with nanostructures based on carbon may, for example, consist of carbon nanotubes (single-walled and multi-walled), carbon nanofibres (herringbone, platelet and screw types) and the like.

With regard to metal nanowires, reference is made to WO 2007/022226 A2, the disclosure of which with regard to the nanowires disclosed therein is incorporated into the present invention by reference. The highly electrically conductive and substantially transparent silver nanowires described in WO 2007/022226 A2 are particularly suitable for the present invention.

By using particles with nanostructures, the electrical conductivity can thereby be configured suitably or the flexibility and insensitivity to hairline cracking can thereby be improved, i.e. a suitable elasticity (E modulus) can be achieved.

The breakdown strength of air is 3 KV/mm and that of polycarbonate is 25 to 35 KV/mm, PVF (Tedlar®) has 25 KV/mm, PTFE has 40 to 80 KV/mm, PVC has 50 KV/mm, crystalline polyethylene terephthalate (PET) has 60 KV/mm, polypropylene has 100 KV/mm, ABS has 120 KV/mm, PEEK has 190 KV/mm and PI (polyimide, e.g. Kapton®) has 240 KV/mm. The breakdown strength of a few mm thick foam, depending on the polymer used, will therefore lie between air and the breakdown strength of the polymer, the degree of the compression of the foam playing an essential part. When using a 20 μm thick polycarbonate sheet, a breakdown strength of about 500 to 700 volts is achieved. Of course, the thicknesses of the conductive and nonconductive layers must be selected so that sparkover is reliably avoided at the electrical voltages respectively being used. Here, the water vapour permeability or the presence of a relative humidity in the foam also plays an essential part; the compression of the foam element should also be taken into account.

In an exemplary embodiment, with an audio voltage or bias voltage of 1800 volts between a 20 μm thick polycarbonate sheet and a 0.3 to 4.0 mm thick foam, a good sound quality can be achieved, no voltage sparkovers occur even with a high relative humidity and no degradation effects occur even in continuous-load operation.

For the electrical contacting of the electrodes, care should be taken that relatively high voltages are used with relatively small currents. However, the contact sites should be well terminated in an insulating fashion, or covered, so that no surface creep currents can occur owing to air moisture and dust.

In another preferred embodiment, the loudspeaker according to the invention may be formed integrally with the drive electronics of the audio amplifier and/or the bias voltage. In this case, the corresponding drive electronics of the audio amplifier and/or the bias voltage may be provided on a substrate, which also carries the loudspeaker of the invention. Preferably printed circuit boards and/or cards, which then serve as a substrate for the loudspeaker according to the invention, may be envisaged as substrates in this case.

As already mentioned, the laminated loudspeaker may additionally be equipped with a protective sheet on the outer surface. This may be rendered transparent and easily cleanable, and with a high wear resistance, and it may also be graphically configured on the rear side. The graphical configuration may be carried out by means of screen printing, transfer printing, inkjet printing and similar printing methods extending to offset printing, flexographic printing and screen intaglio printing. Following the graphical configuration, the aforementioned additional front protective electrode may then be produced by printing technology, preferably by means of screen printing. For example, a commercially available carbon screen printing paste with a sheet resistance of less than 1 kohm/square may be used for this. In order to reduce the stress crack susceptibility of this protective electrode, a few per cent by weight of MWCNTs (multi-walled carbon nanotubes) may be added. In principle an intrinsically conductive polymer, for example Baytron P®, may be added instead of or in addition to the carbon-based printing ink so that better formability or extensibility is achieved.

It is possible to shape the loudspeaker according to the invention three-dimensionally. Precise three-dimensional shaping of graphically configured plastic sheets with very short cycle times of a few seconds can be carried out according to the prior art by the isostatic high-pressure forming method (HPFM), which is described in detail in EP 0 371 425 B1 and requires the use of cold-stretchable sheets, for example sheets with the designation Bayfol® CR (PC/PBT sheet) or Makrofol® DE from Bayer AG. Besides the thermoplastic sheet formable below Tg, correspondingly formable screen printing inks are preferable for achieving optically attractive products, for example inks from Pröll KG, D-91781 Weiβenburg, Bavaria with the designation Aquapress® or Noriphan®.

In addition to the graphical configuration, this protective sheet or the entire sheet structure or a part of it may be formed with a tactilely configured surface, for example minor surface embossing may be formed. In this embodiment, it should be borne in mind that the layer composite is configured so thinly and flexibly that this layer composite functions as a sound-emitting diaphragm and offers good reproduction quality. A preferred surface will in this case be achieved with a very thin polycarbonate sheet in the range of 20 μm, or by using a PVF sheet in the same thickness range, or in more economical embodiments a thin oPP sheet in the range of from 9 μm to 33 μm thickness may be used.

For the specific structure of a laminated loudspeaker according to the invention with a single elastic interlayer, the following layer structure is proposed:
a a first nonconductive layer as a stabilising and inertial element with a mass per unit area of at least 10 times the other layers,
b a conductive layer,
c the single elastic nonconductive layer,
d a conductive layer,
e a nonconductive insulation layer of a plastic sheet.

In this specific embodiment, for example, the conductive layer according to the aforementioned Feature b may be applied on an additional plastic sheet, so that two plastic sheets coated on one side can be adhesively bonded on either side of the interlayer and this entire sandwich is adhesively bonded onto a solid base, i.e. a stabilising and inertial element.

In addition, a further outer protective layer, in the form of a plastic sheet, may be applied on the sandwich of the laminated loudspeaker. As a protective device, an earthed conductive layer may be used as a protective electrode between the nonconductive layer according to Feature e and the nonconductive layer mentioned last.

Considering the structure of the laminated loudspeaker according to the invention with two elastic interlayers, distinction is to be made between two basic variants, namely a variant in which the laminated loudspeaker has a single preferential sound radiation direction and, on the other hand, a structure in which the preferential sound radiation direction perpendicular to the loudspeaker surface extends in both directions, i.e. forwards and backwards. In the former case of a one-sided radiation direction, an inertial element must be applied on the opposite side, ensuring that the movement of the loudspeaker surface takes place only on one side, whereas without such a flat inertial element movement of the upper side of the laminated loudspeaker would take place on both sides.

Accordingly, a laminated loudspeaker for one-sided radiation with two elastic interlayers is provided, which has the following layer structure:
a a first nonconductive layer as a stabilising and inertial element,
b a conductive layer,
c the first elastic nonconductive layer,
d a conductive layer,
e the second elastic nonconductive layer,
f a conductive layer,
g a nonconductive insulation layer of a plastic sheet.

The conductive layers may respectively be applied on a plastic sheet, and it is possible to arrange an additional outer nonconductive layer of a plastic sheet as an outer protective layer. An additional conductive sheet may furthermore be provided as a protective electrode, which has an earth connection, between the outer nonconductive layers.

In principle, the two elastic layers may be formed with the same thickness, so that in principle the two sandwiches have similar properties. It may however also be particularly advantageous to configure the elastic layers with different thicknesses, so that the thinner layer can be used preferentially for the generation of high frequencies and the thicker layer can be used for the generation of lower frequencies with a larger excursion.

With regard to the specific structure of the laminated loudspeaker according to the invention with two elastic layers and radiation on both sides, it is proposed that in this loudspeaker precisely two elastic layers separated from each other should enclose a conductive layer or a plastic sheet conductively coated on at least one side, with a frame surrounding the layers of the loudspeaker peripherally as a stabilising and inertial element and having a conductive layer, which is covered by at least one nonconductive insulation layer on both sides of the elastic layers. In this case, the outer conductive layer may be applied on an additional plastic sheet, and it is also possible to arrange a nonconductive layer of a plastic sheet as an outer protective layer on both sides. An earthed conductive layer may furthermore be provided as a protective electrode below the outer protective layer, so that it acts as an additional protective device.

In addition, another particularly favourable layer structure according to the invention will be proposed for the loudspeaker, which above all has the advantage of also being particularly highly suitable for the generation of deeper frequencies. The layer structure is represented as follows:
1. front side made of polycarbonate sheet, preferably formed air-tightly,
2. an electrically conductive layer of the sheet according to 1.,
3. an elastic and air-permeable interlayer, for example a soft textile fabric,
4. an electrically conductive layer, formed air-permeably, for example as a fine metal fabric,
5. a stiff but air-permeable layer with a multiple layer thickness compared with the first elastic interlayer, for example a honeycomb pattern approximately 10 mm thick,
6. a stiff plate is fixed on the layer according to 5. as the rear side.

Owing to the air permeability of a large part of the layers, this structure is particularly suitable with regard to the volume which can be generated at deeper frequencies, since the elastic interlayer is not dampened by the air cushion and is not stiffened by the enclosed air.

### BRIEF DESCRIPTION OF THE DRAWINGS

FIG. 1: shows a basic embodiment of a single-sandwich laminated loudspeaker with a sound radiation direction on both sides;

FIG. 2: shows a basic embodiment of a single-sandwich laminated loudspeaker with a sound radiation direction on one side;

FIG. 3: shows a single-sandwich laminated loudspeaker with a sound radiation direction on one side and a protective electrode;

FIG. 4: shows a single-sandwich laminated loudspeaker with a sound radiation direction on one side, a protective electrode, an outer protective layer and a residual current protection switch;

FIG. 5: shows a single-sandwich laminated loudspeaker with a sound radiation direction on both sides and outer protective layers;

FIG. 6: shows a single-sandwich laminated loudspeaker with a sound radiation direction on one side, an inner protective sheet and an outer protective layer;

FIG. 7: shows a basic embodiment of a single-sandwich laminated loudspeaker with a sound radiation direction on both sides and a frame as an inertial element;

FIG. 8: shows a basic embodiment of a double-sandwich laminated loudspeaker with a sound radiation direction on both sides, with an asymmetric structure;

FIG. 9: shows a basic embodiment of a double-sandwich laminated loudspeaker with a sound radiation direction on both sides, with a symmetrical structure without a protective electrode and without a protective layer;

FIG. 10: shows a double-sandwich laminated loudspeaker with a sound radiation direction on both sides, with a symmetrical structure having a protective electrode and having a protective layer;

FIG. 11: shows a double-sandwich laminated loudspeaker with a sound radiation direction on one side, having an outer protective sheet and an outer protective layer;

FIG. 12: an embodiment of a single-sandwich laminated loudspeaker with a sound radiation direction on one side, which is particularly favourable for deeper frequencies.

### DETAILED DESCRIPTION

The invention will be described in more detail below with reference to the preferred exemplary embodiments with the aid of the figures, only the features necessary for understanding the invention being represented and the following references being used: 1: first nonconductive sheet; 2: second nonconductive sheet; 3: first electrically conductive layer; 4: second electrically conductive layer; 5: first interlayer; 6: second interlayer; 7: carrier sheet; 8: third electrically conductive layer; 9: high-voltage supply; 10: audio source; 11: heavy wall/heavy flat element; 12: conducting protective electrode; 13: protective switch/residual current switch; 14: outer protective lacquer layer; 15: capacitor; 16: frame as inertial element; 17: outer insulating protective sheet; 18: protective sheet between flat inertial element and first conductive layer; 19: holes/openings; 20: principal sound radiation direction; 21 protective earthing/earth connection.

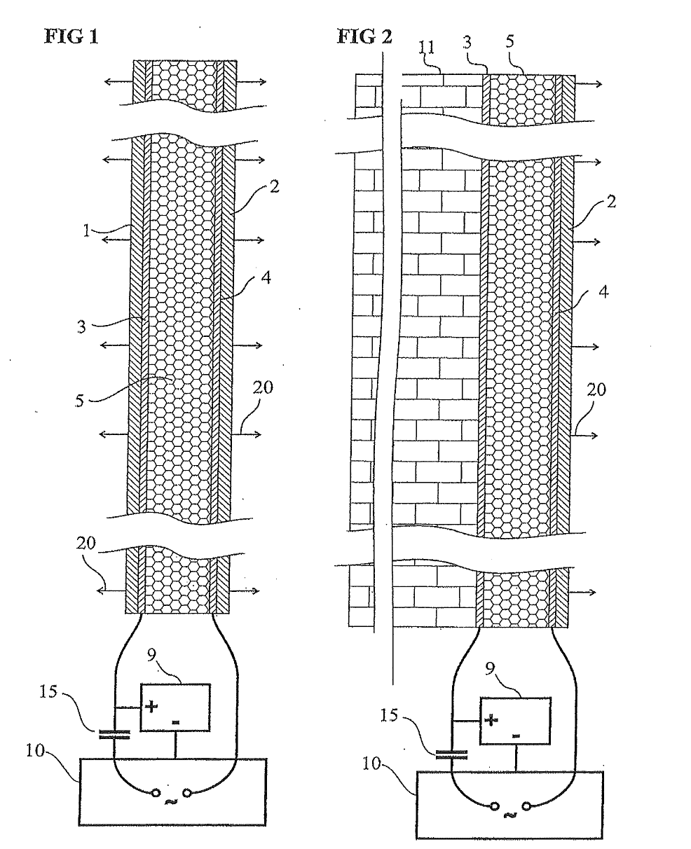

FIG. 1 represents a very simple basic variant of the laminated loudspeaker according to the invention. It consists of two sheets 1 and 2, each of which is coated with a metal layer 3 and 4, respectively, on the side facing the inside of the loudspeaker, and which enclose an elastic foam 5. The electrically conductive layers 3 and 4 are connected to a high-voltage supply 9, which generates a static electric field between the layers 3 and 4 during operation and force the metal layers 3 and 4, and the sheet layers 1 and 2 connected to them, against the elastic resistance of the foam 5 owing to the attraction forces of the electric field.

By a capacitor 15, with the aid of an audio source 10, an audio frequency is superimposed separately on the voltage potential generated by the high-voltage supply 9 so as to cause different deflections of the sheets 1 and 2 which are firmly connected to the electrically conductive layers 3 and 4, according to the varying voltages or counter-voltages. These deflections of the outer loudspeaker layer generate pressure variations in the surrounding air, which at corresponding frequencies are perceptible as tones for the human ear.

The audio source (represented only schematically in the figures) is in most cases a combination of an audio transmitter with an upstream audio amplifier. However, it is also within the scope of the invention to use a correspondingly equipped, directly connected amplifier without an interconnected audio transmitter.

In the embodiment represented in FIG. 1, a voltage variation between the conductive layers 3 and 4 generates a deflection of the two outside surfaces of the loudspeaker, around a centroid line lying in the middle, so that sound radiation is induced in both directions to the left and right of the loudspeaker. The sound propagation direction resulting from this is indicated by the arrows 20 in this figure, as well as in the other FIGS. 2 to 12.

According to the object of the invention as presented above, it is very easy to produce such a laminated loudspeaker—as shown for example in its basic form in FIG. 1—since only two sheets coated for example with aluminium, preferably polycarbonate sheets, need to be applied onto a thin foam and adhesively bonded to it. Such sandwich constructions can readily be produced in a large size and, for example, packaged as rollware. These laminated loudspeakers shown here can be adhesively bonded without difficulty onto large surfaces, for example on the walls of large rooms, in a similar way to wallpaper and owing to their large area of several square metres and the large distribution of the sound source thereby generated, they generate an entirely new sound sensation which is virtually independent of the listener's location over a large range.

FIG. 2 shows a similar embodiment of the laminated loudspeaker according to FIG. 1. Here, however, instead of the sheet 1 on the left-hand side of the laminated loudspeaker, a wall 11 is applied which is solid relative to the rest of the laminated loudspeaker and owing to its inertia ensures that almost exclusively the right-hand side, i.e. the surface of the sheet 2, is moved relative to the surroundings during field variation-induced movements of the sandwich surface of the loudspeaker according to the invention, so that radiation of the sound takes place almost exclusively to the right, i.e. on the opposite side from the wall 11.

In principle, this effect may also be achieved by the structure—as shown in FIG. 2—being fitted on the left-hand side on a wall 11 or adhesively bonded to it, so that an insulation layer is additionally formed between the conductive layer 3 and the heavy wall 11. In this way, in particular, the application of adhesive between the wall 11 and the actual loudspeaker sandwich would not entail problems, and possible damage to the conductive layer 3 during the adhesive bonding would be avoided. Since the conductive layer 3 does not however need to be mechanically set in oscillation by the AC voltage variation of the audio source, here even a somewhat solid and thicker layer may be used instead of a thin coating, for example an aluminium sheet for example with a thickness of 100 or 200 μm, which per se already has some degree of protection against mechanical damage.

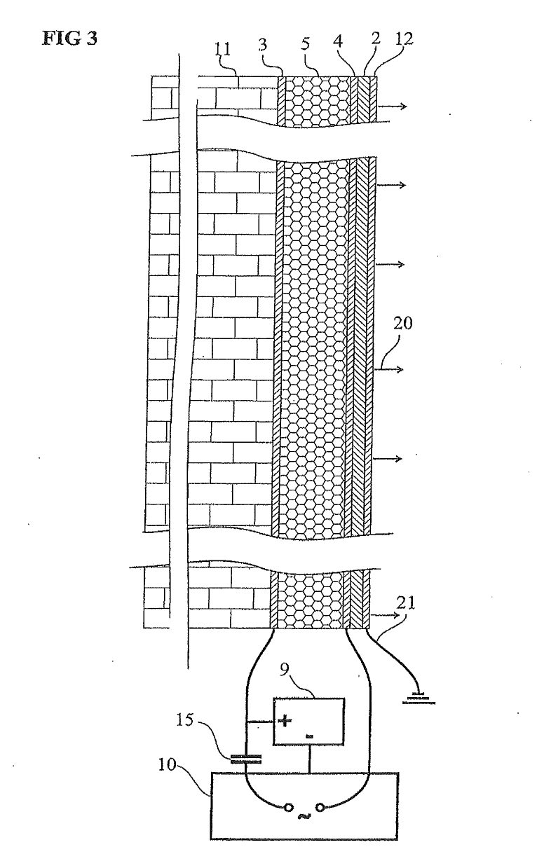

FIG. 3 shows an improvement of the embodiment in FIG. 2. The improvement of this embodiment consists in an additional protective electrode 12, which is provided with earthing 21, being applied on the front side of the loudspeaker sandwich, i.e. as seen in the sound radiation direction 20. If such a protective electrode is applied on the front side of the loudspeaker sandwich, then this prevents currents with a high potential from being able to flow out of the high-voltage supply 9 in the event of possible damage to the surface, which greatly reduces the potential hazard of laminated loudspeakers fitted in the direct vicinity of the public.

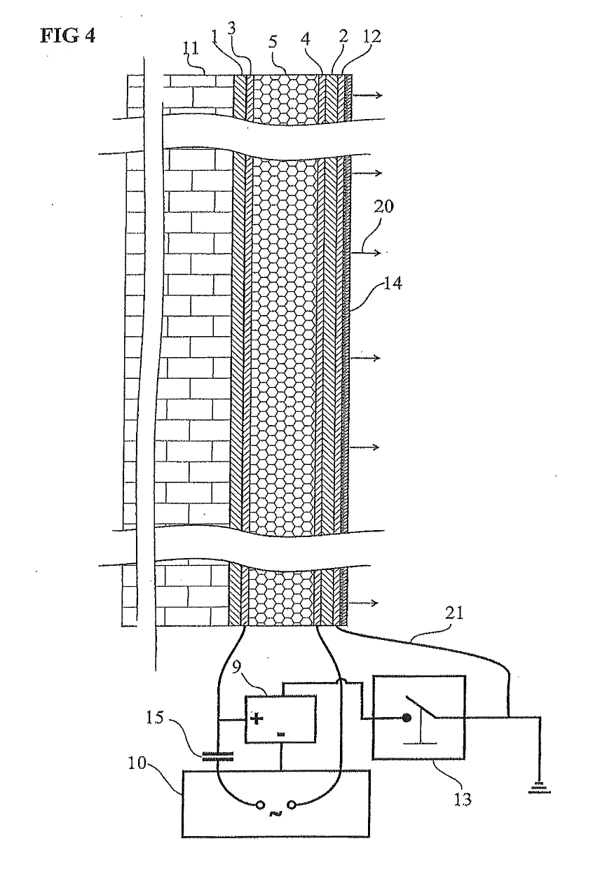

A further improvement of this embodiment according to FIG. 3 is represented in FIG. 4. Here, in addition to the protective electrode 12 applied in the front region, an additional nonconductive layer 14 is applied in the form of a nonconductive lacquer 14, which additionally protects the layers lying behind it against mechanical stress.

According to the invention, such a lacquer layer may on the one hand be configured to be colourless or one-coloured, or it is also possible to apply this lacquer layer in the form of decoration so that, for example, posters or advertising panels or other display boards or the like can thereby be formed.

In addition, a nonconductive sheet 3 is provided in this embodiment between the heavy wall 11 and the second electrically conductive layer 3, which as already mentioned above makes it much easier to apply such a laminated loudspeaker according to the invention onto the heavy wall 11.

The example shown in FIG. 4 furthermore represents an additionally improved protective device that has a residual current switch 13, which immediately earths the high voltage in the event that a sudden voltage drop is detected between the two conductive layers 3 and 4 or a short-circuit between the conductive layers 12 and 4, so that no hazard is possible for any public who may be present. Furthermore, the high-voltage supply may also be turned off directly by this switch.

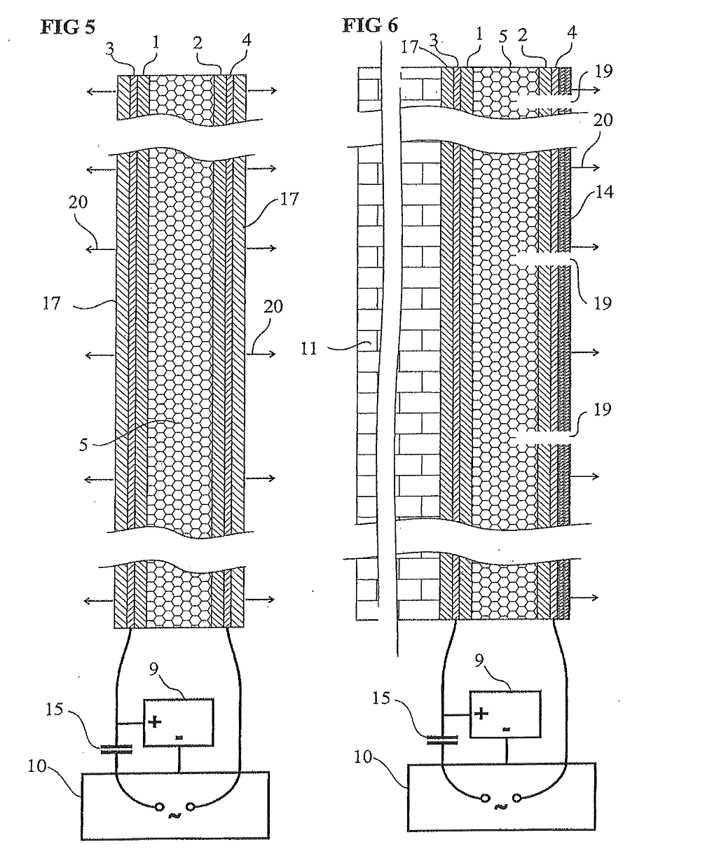

Lastly, FIG. 5 shows an embodiment according to the invention of a laminated loudspeaker according to FIG. 1, although a nonconductive protective sheet 17 is additionally arranged respectively on the outer sides of the loudspeaker sandwich as a protective device here. The orientation of the coated sheets 1 and 2, respectively, is furthermore reversed in relation to FIG. 1 so that now the electrically conductive layers 3 and 4 no longer lie directly on the elastic interlayer; rather, the sheets 1 and 2 bear directly on it and therefore can also readily be bonded adhesively to this elastic interlayer 5.

FIG. 6 shows a similar situation as in FIG. 5, although here a heavy and massive wall 11 is additionally arranged on the left-hand side. This heavy wall 11 is followed by a protective layer in the form of a protective sheet 17, then by a conductive layer 3 on the first nonconductive sheet 1. After this comes the elastic layer in the form of a thin foam 5, followed by the second sheets 2 with the electrically conductive layer 4, which is vapour-deposited on it and is coated with a protective lacquer 14 and/or an air-permeable lightweight fabric or a spunlaid nonwoven, or in general a nonwoven.

A multiplicity of openings 19 are furthermore made in the side facing the sound propagation direction 20, which ensure air exchange between the elastic layer 5 and the outside world so that compression of the air in the elastic layer does not need to take place when the elastic layer contracts or expands owing to the AC audio voltage. This measure can lead to a substantial improvement in the audio quality of the proposed loudspeaker.

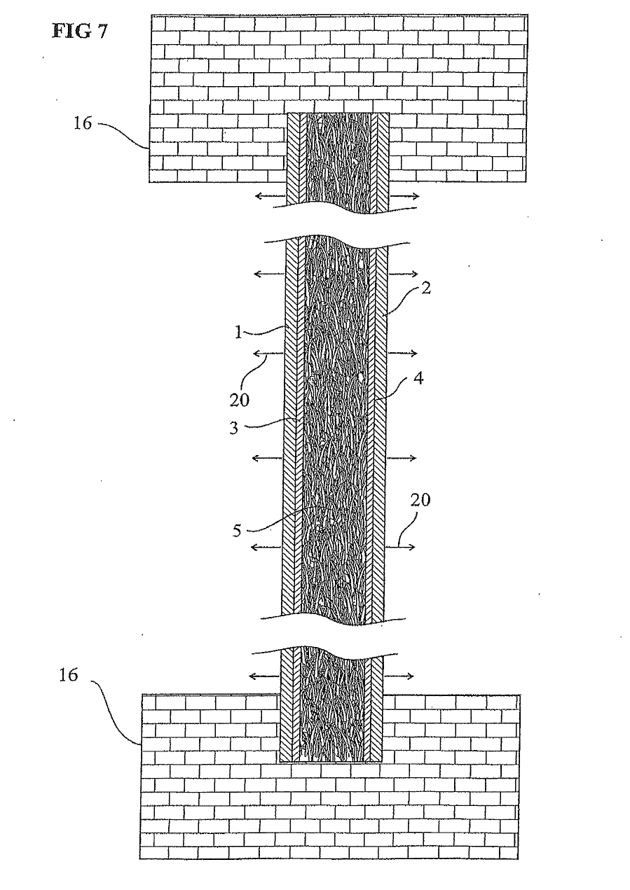

Another variant of the embodiment according to the invention of a laminated loudspeaker is represented in FIG. 7. The basic structure of the sheet sandwich is configured here similarly to FIG. 1, although it is indicated that instead of a foam for the interlayer 5, a so-called nonwoven material is used which consists of a multiplicity of individual fibres that are arranged randomly in their orientation. Such a nonwoven material has the advantage over a foam that relatively easy air exchange takes place within the material, so that simpler ventilation of this flexible interlayer 5 is possible. For example, openings 19—as shown in FIG. 6—may also be made on at least one side here so that good sonic pressure performances can be achieved even with lower audio voltages.

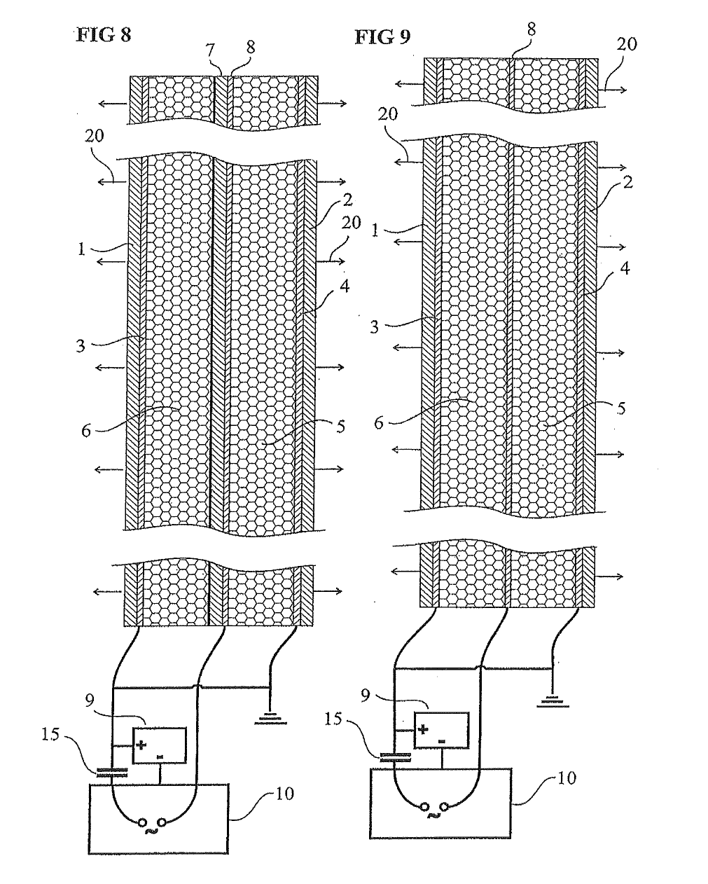

FIG. 7 additionally shows a frame 16, in which the actual sheet sandwich of the loudspeaker is tensioned, the frame 16 serving as an inertial element. With such a frame, for example, it is possible to suspend such sheets in free space similarly to a framed poster, both sides of the laminated loudspeaker serving as a radiation surface.

Whereas FIGS. 1 to 7 show laminated loudspeaker embodiments which have only a single elastic interlayer 5, an embodiment of the laminated loudspeaker according to the invention with two elastic interlayers 5 and 6 will now be shown in the following FIGS. 8 to 11.

In principle, the structure of the laminated loudspeaker of FIG. 8 corresponds to the structure of FIG. 1, although two elastic layers 5 and 6 are inserted between the outer layers instead of a single elastic interlayer 5, these being arranged by a sheet 5 with an electrically conductive coating 8 on one side. In this way, an electric field can be generated between the layers 3 and 8 or the layers 8 and 4. To this end a high-voltage supply 9 is connected, which applies the earth potential to both outer layers 3 and 4 and supplies the central layer 8 with high voltage. In addition, according to the embodiments 1 to 7 shown previously, an audio voltage is applied via a capacitor 15 with the aid of an audio source 10, during the operation of which the surface of the laminated loudspeaker is moved according to the audio voltage and audible sound is thereby generated.

FIG. 9 shows a similar embodiment as FIG. 8, although the inner layer of a nonconductive sheet 7 is omitted in this laminated loudspeaker designed as a double sandwich. Either the middle conductive layer 8 may be applied directly on one of the elastic interlayers 5 or 6, or the conductive layer 8 may be configured as a self-supporting sheet, for example a pure aluminium sheet, which is adhesively bonded to the two interlayers 5 and 6.

Advantages of these embodiments of the laminated loudspeaker according to FIGS. 8 and 9 are that, owing to the always externally placed earth potentials on the layers 3 and 4, a protective device is already integrated inherently into the system by them. Furthermore, the doubly present elastic layers 5 and 6 ensures somewhat improved excursion when using the same audio voltage.

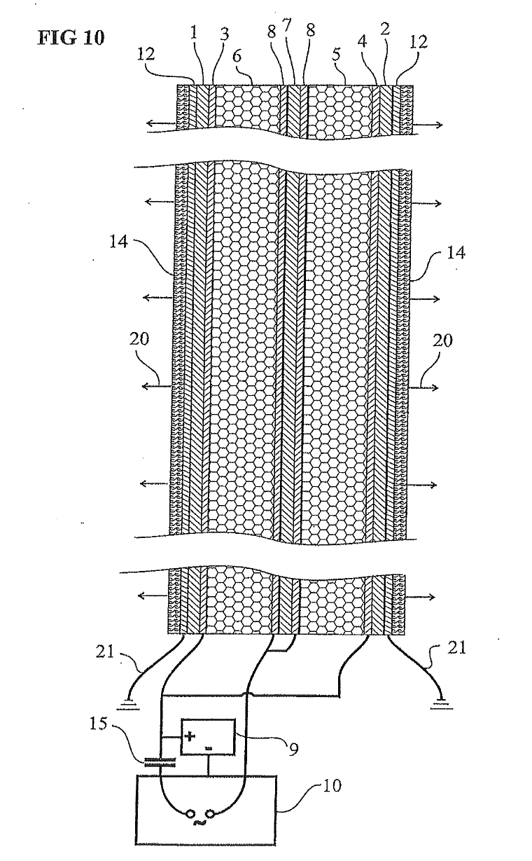

FIG. 10 shows another variant according to the invention of a double-sandwich laminated loudspeaker, in which a sheet 7 coated on both sides with its electrically conductive layers 8 is placed between the two elastic layers 5 and 6. In the outward direction the two elastic layers 5 and 6 are followed by an electrically conductive layer 3 and 4, respectively, which are coupled to the high-voltage supply 9 and the audio source 10. These two layers 3 and 4 respectively lie on a sheet 1 and 2 over which a protective electrode 12 is in turn arranged, which is earthed and finally covered by a protective lacquer 14. This arrangement of the outer protective electrodes 12 and the protective insulating lacquer 14 following thereon likewise generates a protective device which ensures high reliability even in the event of mechanical damage to the laminated loudspeaker.

The alternative embodiments of FIGS. 8 to 10 as represented above respectively show double-sandwich laminated loudspeakers, the sound propagation directions 20 of which are arranged symmetrically.

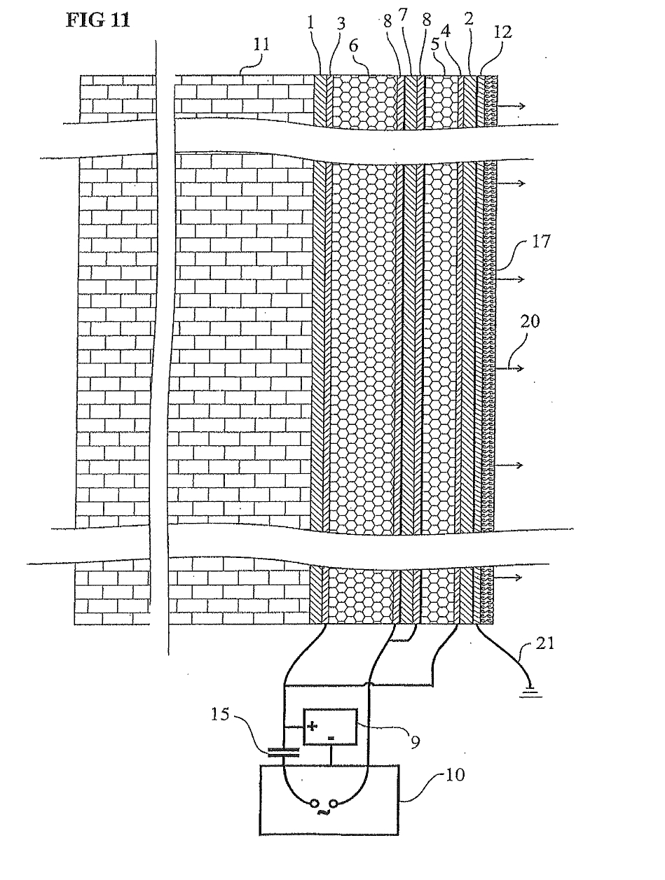

A variant of a double-sandwich laminated loudspeaker with a sound propagation direction on one side is represented in FIG. 11. The structure of this laminated loudspeaker corresponds essentially to the structure of the laminated loudspeaker in FIG. 10, although the protective electrode 12 and the protective lacquer coating 14 have been replaced on one side by a solid inertial element 11, so that essentially the relatively mobile layers provided only with low inertial mass on the right-side move here, and a sound propagation direction 20 is consequently directed to the right.

In addition, the elastic interlayer 5 lying in the sound propagation direction in this alternative embodiment is also configured much more thinly than the second elastic layer 6. For example, this variant makes it possible to use a frequency splitter so that essentially the high tones can be generated in the sandwich directed towards the sound propagation direction whereas the low tones are generated in the thicker layer.

In addition, it is also possible to use different materials for the two elastic layers so that better adaptation to the audio qualities required in different frequency ranges is possible overall.

Owing to the very thin configuration of the laminated loudspeaker according to the invention, it is particularly suitable for broadcasting sound in sizeable spaces by being fitted over a large area on walls, furnishings or other furniture objects, without being visible as a loudspeaker. This laminated loudspeaker may also be integrated into a wide variety of displays or monitors.

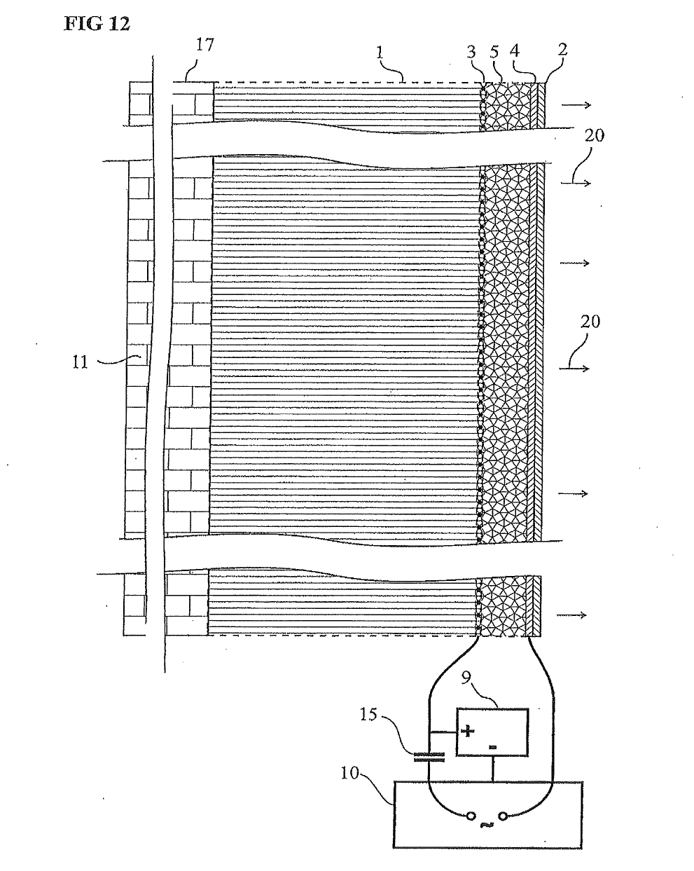

Lastly, FIG. 12 shows another particularly advantageous embodiment of a single-sandwich laminated loudspeaker with a sound radiation direction on one side, which is also particularly favourable for the radiation of deep frequencies. In this figure, all the air-impermeable layers are delimited by solid lines whereas the air-permeable layers are bordered by dashed lines.

The layer structure of this sonic transducer is configured as follows:
1. The front side consists of an airtight polycarbonate sheet 2, i.e. one which is closed surface-wide.
2. An electrically conductive layer 4 is applied, for example evaporation coated, on the polycarbonate sheet.
3. This is followed by an air-permeable elastic interlayer 5; for example, this may be a soft textile fabric.
4. The elastic interlayer 5 is followed by a likewise air-permeable electrically conductive layer 3, which is implemented here in the form of a narrow-meshed thin metal fabric.
5. Lastly, this is followed by a stiff but air-permeable layer 1 which has a multiple layer thickness compared with the first elastic interlayer 5. For example, a honeycomb pattern with a thickness of approximately 10 mm may be used here.
6. A stiff plate, on which the layer 1 is fixed, is arranged on the rear side. This plate may for example also be a building wall or the like.

This structure leads to increased volume at deeper frequencies, since the elastic interlayer 5 is not dampened by the air cushion and is also not stiffened in its resilience by the enclosed air.

It is to be understood that the features of the invention as mentioned above may be used not only in the combination respectively indicated, but also in other combinations or separately, without departing from the scope of the invention.

1.-42. (canceled)

43. A loudspeaker comprising:
a layer structure having a plurality of layers and forming an grounded conductive layer active sound-radiating loudspeaker surface, each layer extending across a loudspeaker surface, the plurality of layers including:
a first diaphragm sheet coated with a first electrically conductive layer;
a second diaphragm sheet coated with a second electrically conductive layer; and
a first elastic, nonconductive interlayer sandwiched between the first diaphragm sheet and the second diaphragm sheet;
a static high-voltage supply electrically coupled to the first and second electrically conductive layers, adapted to generate an electric field between the first electrically conductive layer and the second electrically conductive layer; and
an audio source adapted to influence the electric field via a capacitor.

44. The loudspeaker of claim 43, further comprising a stabilising and inertial element connected to the loudspeaker surface.

45. The loudspeaker of claim 43, wherein the stabilising and inertial element is a frame, between which the layer structure is tensioned.

46. The loudspeaker of claim 43, wherein the plurality of layers further include:
a third electrically conductive layer;
a second elastic, nonconductive interlayer sandwiched between the third electrically conductive layer and one of the first or second diaphragm sheets, the first interlayer being sandwiched between the third conductive layer and the other of the first or second diaphragm sheets;
a plurality of outer conductive layers, with at least one outer conductive layer being on each side of the layer structure; and
a plurality of outer nonconductive insulation layers, with at least one outer nonconductive insulation layer being on each side of the layer structure on each outer conductive layer; and
wherein the loudspeaker further includes a frame surrounding the layer structure peripherally, the frame being adapted as a stabilising and inertial element.

47. The loudspeaker of claim 46, wherein at least one of the plurality of outer conductive layers is applied on a plastic sheet.

48. The loudspeaker of claim 43, wherein the plurality of layers further include additional nonconductive layers, each comprising a plastic sheet is arranged as an external protective layer on both sides of the layer structure.

49. The loudspeaker of claim 48, wherein the plurality of layers further include a plurality of grounded conductive layers, each adapted as a protective electrode, and each being immediately adjacent and below each of the additional nonconductive layers within the layer structure.

50. The loudspeaker of claim 49, wherein each grounded conductive layer is applied on the plastic sheet forming each of the additional nonconductive layers.

51. A loudspeaker, comprising:
a layer structure having a plurality of layers and forming an first nonconductive layer active sound-radiating loudspeaker surface, each layer extending across a loudspeaker surface, wherein all layers are at least partially connected to neighbouring layers, the layers including:
a first nonconductive layer formed from a plastic sheet;
a first conductive layer;
a second conductive layer; and
up to two nonconductive elastic interlayers sandwiched between the first and second conductive layers, wherein each interlayer is adapted to allow movement of neighbouring layer on at least one side of the interlayer for sound generation;
a variable high-voltage supply adapted to apply a bias voltage between the first and second conductive layers, wherein voltage variations in the bias voltage transmit electrical audio signals to at least one of the first and second conductive layers; and
a stabilising and inertial element is connected to the layer structure, and
a protective element covering the layer structure and adapted to protect persons from high-voltage potential in the conductive layers.

52. The loudspeaker of claim 51, wherein the stabilising and inertial element comprises a frame, between which the layer structure is tensioned.

53. The loudspeaker of claim 51, wherein two elastic interlayers are sandwiched between the first and second conductive layers, the stabilising and inertial element comprises a frame surrounding the layer structure peripherally, and the layers further include:
a third electrically conductive layer, wherein the first interlayer is sandwiched between the first and third conductive layers, and the second interlayer is sandwiched between the second and third conductive layers;
a plurality of outer conductive layer, with at least one outer conductive layer being on each side of the layer structure; and
a plurality of outer nonconductive insulation layers, with at least one outer nonconductive insulation layer being on each side of the layer structure on each outer conductive layer.

54. The loudspeaker of claim 51, wherein at least one of the plurality of outer conductive layers is applied on the plastic sheet.

55. The loudspeaker of claim 51, wherein the layers further include additional nonconductive layers, each comprising a plastic sheet arranged as an external protective layer on both sides of the layer structure.

56. The loudspeaker of claim 55, wherein the layers further include a plurality of grounded conductive layers, each adapted as a protective electrode, and each being immediately adjacent and below each of the additional nonconductive layers within the layer structure.

57. The loudspeaker of claim 56, wherein each grounded conductive layer is applied on the plastic sheet forming each of the additional nonconductive layers.
